(19) United States
(12) Patent Application Publication
(10) Pub. No.: US 2024/0092133 A1
(43) Pub. Date: Mar. 21, 2024

(54) Mobile Robot

(71) Applicant: Hitachi High-Tech Corporation, Minato-ku, Tokyo (JP)

(72) Inventors: Toshifumi MITSUYAMA, Tokyo (JP); Yoshiki KANAI, Tokyo (JP); Toru SHIBATA, Tokyo (JP); Yuuko OKADA, Tokyo (JP); Hiroki TAKAHASHI, Tokyo (JP); Tomohiro INOUE, Tokyo (JP)

(21) Appl. No.: 18/272,759

(22) PCT Filed: Feb. 18, 2021
(86) PCT No.: PCT/JP2021/006083

§ 371 Date: Jul. 17, 2023

(51) Int. Cl. B60G 17/016; B25J 5/00; B60G 3/00

(52) U.S. Cl. CPC B60G 17/016; B25J 5/007; B60G 3/00; B60G 2202/422; B60G 2204/4193; B60G 2500/30

(57) ABSTRACT

The present invention provides a mobile robot that can simultaneously absorb an impact received from an uneven road surface while moving and estimate the position or orientation of the mobile robot while functioning. The mobile robot according to the present invention has an operation mechanism having a multi-jointed arm, and a movement mechanism that causes the operation mechanism to move, the mobile robot being characterized in that: the movement mechanism has a first support part and a second support part, which support the weight of the movement mechanism; and the second support part is installed at a position that is nearer to an outer peripheral section, in terms of the movement direction of the movement mechanism, than is the installation position of the first support part.

### TECHNICAL FIELD

The present invention relates to a mobile robot having an articulated arm mounted on a movement mechanism (for example, a carriage). In particular, the present invention relates to a mobile robot that grasps a work target, moves to a work place (for example, a workbench), and performs various works.

### BACKGROUND ART

In recent years, a dual-arm robot with an articulated arm and a mobile robot, in which a single robot arm is mounted on a cart that can move autonomously, have been researched and developed. The mobile robot can carry a work target, move to a workbench, use various tools on the workbench, and automatically perform various works.

JP2017-94470A (hereinafter referred to as PTL 1) is a background art in such a technical field.

In PTL 1, a robot that can be easily moved and installed, can prevent deviations in position and posture of the robot, has a plurality of moving portions for moving the robot and an operation portion, and has a fixing portion that makes the robot become separate from a ground surface by moving at least one of the plurality of moving portions by operating the operation portion is described (refer to abstract of PTL 1).

### CITATION LIST

### Patent Literature

PTL 1: JP2017-94470A

### SUMMARY OF INVENTION

### Technical Problem

PTL 1 describes a robot (mobile robot) having the fixing portion that separates the robot from the ground surface. In other words, the mobile robot described in PTL 1 prevents displacement of the mobile robot when the articulated arm is operating by means of the fixing portion to prevent displacement of the position and posture of the mobile robot when the articulated arm is operating.

In general, since a mobile robot may move on an uneven road surface, it is necessary to reduce rigidity of a structure that supports a wheel, absorb an impact received from the uneven road surface when the mobile robot moves, and prevent a posture change of the mobile robot when moving.

A mobile robot with an articulated arm shifts a center of gravity on a cart when the articulated arm is operating. Therefore, it is necessary to increase rigidity of a structure that supports a wheel, and to prevent a posture change of the mobile robot when the mobile robot is operating so that position and posture of the mobile robot do not change when the articulated arm is operating.

As such, in the mobile robot having the articulated arm, the rigidity of the structure that supports the wheel is set according to the movement of the mobile robot and the operation of the articulated arm.

For example, a mobile robot that carries liquid as a work target, moves to a workbench, and performs precise dispensing work (operation) and stirring work (operation) on the workbench needs to absorb an impact received from an uneven road surface so that the mobile robot does not spill the liquid when moving, and maintain position and posture of the robot, that is, prevent a change in the posture, so that the robot can perform precise dispensing and stirring works during operation.

In other words, such a mobile robot is required to simultaneously absorb an impact received from an uneven road surface while moving and maintain position and posture of the mobile robot during operation.

However, PTL 1 does not describe a mobile robot that simultaneously absorbs an impact received from an uneven road surface during movement and maintains position and posture of the mobile robot during operation.

Accordingly, the present invention provides a mobile robot that simultaneously absorbs an impact received from an uneven road surface during movement and maintains position and posture of the mobile robot during operation.

### Solution to Problem

To solve the problem described above, a mobile robot of the present invention is a mobile robot that has a working mechanism having an articulated arm and a movement mechanism for moving the working mechanism, where the movement mechanism has a first support portion and a second support portion for supporting a weight of the mobile robot, and the second support portion is installed at a position closer to an outer periphery portion than an installation position of the first support portion with respect to a movement direction of the movement mechanism.

### Advantageous Effects of Invention

According to the present invention, it is possible to provide a mobile robot that simultaneously absorbs an impact received from an uneven road surface during movement and maintains position and posture of the mobile robot during operation.

Problems, configurations, and effects other than those described above will be clarified by the description of examples below.

### BRIEF DESCRIPTION OF DRAWINGS

FIG. 1 is an explanatory diagram for illustrating an appearance of a mobile robot 1 described in a first example.

FIG. 2 is an explanatory diagram for illustrating a structure of a movement mechanism 20 of the mobile robot 1 described in the first example.

FIG. 3 is an explanatory diagram for illustrating a structure of a second support portion 220 of the mobile robot 1 described in the first example.

FIG. 4 is an explanatory diagram for illustrating a state of the mobile robot 1 when moving described in the first example.

FIG. 5 is a schematic diagram for illustrating a support structure of the mobile robot 1 when moving described in the first example.

FIG. 6 is an explanatory diagram for illustrating a state when the mobile robot 1 described in the first example has moved to a workbench 50 and stopped.

FIG. 7 is a schematic diagram for illustrating a support structure when the mobile robot 1 described in the first example has moved to the workbench 50 and stopped.

FIG. 8 is a graph for illustrating time transitions of a load N11F acting on a front first support portion 210 and a load N21 acting on the second support portion 220 of the mobile robot 1 described in the first example.

FIG. 9 is an explanatory diagram for illustrating a state when the mobile robot 1 described in the first example is working on the workbench 50.

FIG. 10 is a schematic diagram for illustrating the support structure of the mobile robot 1 described in the first example when the robot is working on the workbench 50.

FIG. 11 is a graph for illustrating time transitions of a load N12F acting on the front first support portion 210 and a load N22 acting on the second support portion 220 of the mobile robot 1 described in the first example.

FIG. 12 is an explanatory diagram for illustrating a structure of a movement mechanism 20 of a mobile robot 1 described in a second example.

FIG. 13 is an explanatory diagram for illustrating a structure of a moving mechanism 20 of a mobile robot 1 described in a third example.

FIG. 14 is an explanatory diagram for illustrating an enlarged view of a vicinity of a second support portion 220 of the mobile robot 1 described in the third example.

### DESCRIPTION OF EMBODIMENTS

Examples of the present invention will be described below with reference to the drawings. Substantially functionally identical or similar configurations are denoted by the same reference numerals, and redundant description thereof may be omitted.

### First Example

First, an appearance of a mobile robot 1 described in a first example will be described.

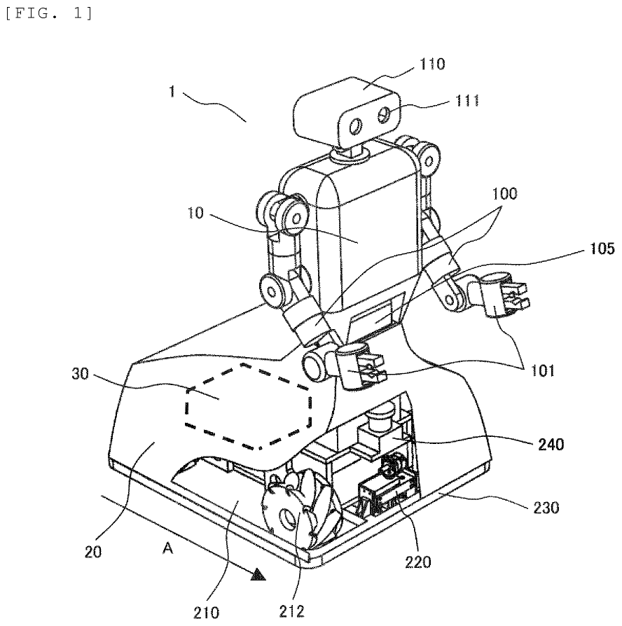

FIG. 1 is an explanatory diagram for illustrating the appearance of the mobile robot 1 described in the first example. In FIG. 1, a part of a cover of a movement mechanism 20 of the mobile robot 1 is removed so that an internal structure can be seen to easily understand the internal structure of the movement mechanism 20 of the mobile robot 1.

The mobile robot 1 described in the first example has a working mechanism (hereinafter referred to as a dual-arm robot 10) having articulated arms 100 and a head portion 110. However, the mobile robot 1 is not limited thereto. For example, the mobile robot 1 may be a combination of two robots, a right-arm single-arm robot and a left-arm single-arm robot. The two robots may be different types of robots. The robot may be composed of only a single arm, and is not limited by the number of arms.

Then, the mobile robot 1 moves while estimating position of the robot autonomously, maintains position and posture of the robot, and can stably travel on wheels on an uneven road surface.

The mobile robot 1 performs various works and includes the dual-arm robot 10 having the articulated arms 100, the movement mechanism 20 for moving the dual-arm robot 10, and a control unit 30 for controlling operations thereof.

The dual-arm robot 10 has two (left and right) articulated arms 100 each having actuators built in each joint, and a hand (gripper) 101 for gripping a work target and performing various works (manipulations) is installed at a tip of the articulated arm 100.

The dual-arm robot 10 also has a head portion 110, and a stereo camera unit 111 having two imaging elements and two lens units is installed (incorporated) inside the head portion 110. As such, the binocular stereo camera unit 111 can measure a distance to a workbench and a distance to a target point on the workbench, and the position and posture can be corrected by observing the work target or target marker.

The dual-arm robot 10 is installed in front of (in a working direction) the movement mechanism 20. That is, the dual-arm robot 10 is installed at a position (installation position of the dual-arm robot 10) with respect to the moving mechanism 20, biased toward a forward movement direction (arrow A direction in FIG. 1) of the mobile robot 1. With such an installation position of the dual-arm robot 10, the dual-arm robot 10 can be brought closer to the workbench.

The dual-arm robot 10 is installed to be tilted forward (in a working direction) with respect to the movement mechanism 20. That is, the dual-arm robot 10 is installed so that a waist portion of the robot is tilted forward in a movement direction (the arrow A direction in FIG. 1) of the mobile robot 1. Here, the dual-arm robot 10 has a waist portion 105 that can be tilted in the working direction (the arrow A direction in FIG. 1). That is, the dual-arm robot 10 can be tilted forward (in the arrow A direction in FIG. 1) of the mobile robot 1 by tilting the waist portion 105.

By tilting the waist portion 105 of the dual-arm robot 10 forward as such, it is possible to improve workability on the workbench.

The movement mechanism 20 has a rotary actuator (not illustrated) driven by an operation command from the control unit 30. Power of the rotary actuator is transmitted by various power transmission means to a wheel 212 made of, for example, resin, and the mobile robot 1 moves by rotating the wheel 212.

In the movement mechanism 20, the wheel 212 is called a mecanum wheel and has a barrel-shaped member of which a surface (on a circumference) is inclined at 45° with respect to an axle. All wheels 212 have rotary actuators for each wheel 212 so that they can be driven independently. By adjusting and controlling the rotation direction and speed of each rotary actuator, it is possible to perform translational movement in front, rear, left, and right directions, and to rotate on the spot.

The movement mechanism 20 includes a laser range finder 240 that measures a distance between an obstacle such as a wall or a target object such as a workbench and position of the robot while the mobile robot 1 is moving, and a bumper 230 that absorbs an impact when colliding with an obstacle. Since the laser range finder 240 can detect obstacles while the mobile robot 1 is moving, the mobile robot 1 can move autonomously.

As such, the mobile robot 1 includes position detecting means for measuring a distance of the stereo camera unit 111 and the laser range finder 240, and the control unit 30 for calculating position (position data) of the robot obtained by the position detecting means.

The movement mechanism 20 also includes a first support portion 210 and a second support portion 220.

As such, the mobile robot 1 includes the dual-arm robot 10 having the articulated arms 100, and the movement mechanism 20 having the first support portion 210 and the second support portion 220 that support the weight of the mobile robot 1. Thus, the mobile robot 1 simultaneously absorbs (impact absorption from the road surface during movement) the impact received from uneven road surface while moving and maintains the position and posture of the mobile robot during operations (precision operations) that require precision.

In the mobile robot 1, which transports liquids such as reagents and samples as work targets (transport targets) and performs precise dispensing and stirring works on the workbench, the robot absorbs the impact received from the uneven road surface so that the liquid does not spill during movement, and maintains the position and posture of the mobile robot 1 to perform precise dispensing and stirring works during movement.

In other words, such a mobile robot 1 simultaneously realizes the absorption of the impact received from an uneven road surface during movement and the maintenance of the position and posture of the mobile robot 1 during operation.

Next, a structure of the movement mechanism 20 of the mobile robot 1 described in the first example will be described.

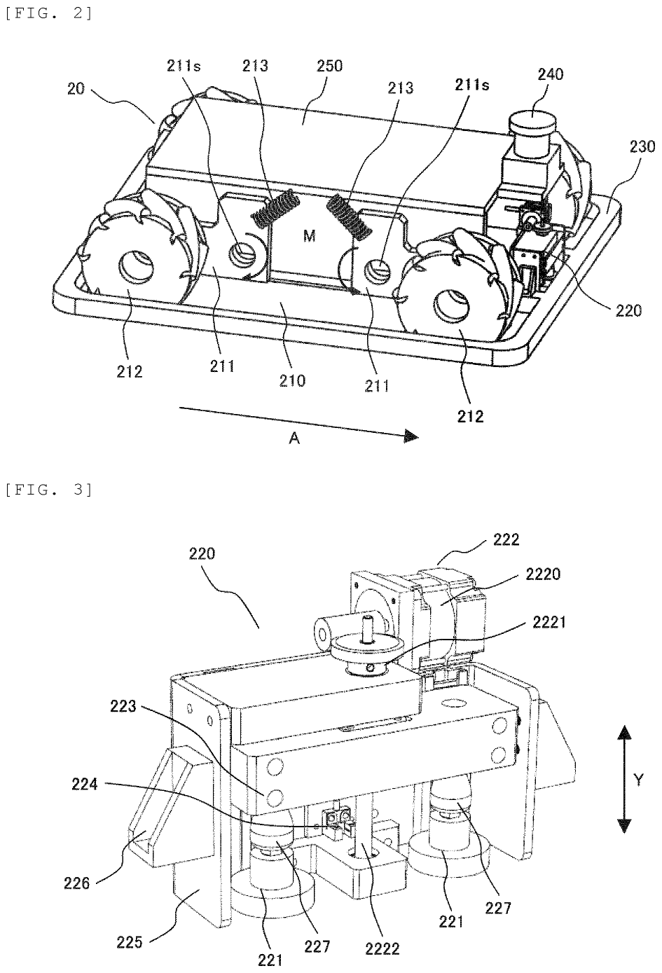

FIG. 2 is an explanatory diagram for illustrating the structure of the movement mechanism 20 of the mobile robot 1 described in the first example. In FIG. 2, a cover of the movement mechanism 20 of the mobile robot 1 is removed so that an internal structure can be seen to easily understand the internal structure of the movement mechanism 20 of the mobile robot 1.

The movement mechanism 20 has a vehicle body 250 which is a vehicle body of the movement mechanism 20, the first support portion 210, and the second support portion 220.

The first support portion 210 is a member that supports the weight of the mobile robot 1 at all times. The first support portion 210 includes four front, rear, left, and right swing portions 211 that swing around four swing axles 211s in the front, rear, left, and right sides and can be displaceable, four front, rear, left, and right wheels 212 that are rotatably installed at ends of the four swing portions 211 and driven by power of rotary actuators (not illustrated), and four displaceable front, rear, left, and right elastic portions 213 that apply biasing forces to make the four wheels 212 in constantly contact with a ground surface (for example, a floor) and generate a reliable driving force in the four wheels 212. As such, the first support portions 210 are installed at four locations on the front, back, left, and right of the movement mechanism 20.

In the first example, the swinging portion 211 has an L-shape. A swing axle 211s is formed at the bent portion of the L shape, an elastic portion 213 is installed at the tip of one side of the L shape, and a central axle of the wheel 212 is installed at the tip of the other side of the L shape.

One end of the elastic portion 213 is connected to the swing portion 211 and the other end is connected to the vehicle body 250. The elastic portion 213 is, for example, a coil spring that deforms in a compression direction and generates an elastic force.

When the first support portion 210 supports the weight of the mobile robot 1, the swing portion 211 swings in a direction of arrow M in FIG. 2 around the swing axles 211s. Due to the swinging motion, the elastic portion 213 is deformed and a spring force acts to support the weight of the mobile robot 1. The elastic portion 213 may have damper performance.

Next, a structure of the second support portion 220 of the mobile robot 1 described in the first example will be described.

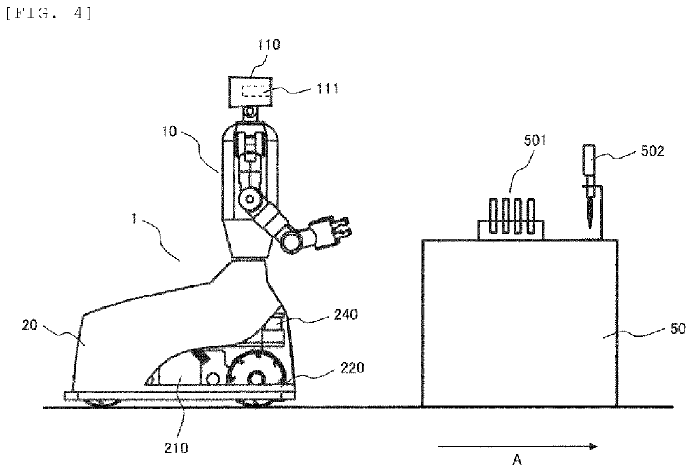

FIG. 3 is an explanatory diagram for illustrating the structure of the second support portion 220 of the mobile robot 1 described in the first example.

The second support portion 220 is an operating mechanism (linear motion actuator) that changes a state between when the mobile robot 1 is moving and when the mobile robot 1 is operating. The second support portion 220 includes a linear moving portion 222, a moving body 223 that moves up and down by the linear moving portion 222, a contact portion 221 that is installed on a moving body 223 that moves up and down by a linear motion actuator (linear moving portion 222), comes into contact with the ground surface when extended (during operation), and separates from the ground surface when contracted (during movement), a photointerrupter 224 that detects excessive movement of the moving portion 223, and a frame 225 that holds all of the second support portion 220.

Thus, the second support portion 220 has a linear motion actuator that vertically moves the moving body 223, and the linear motion actuator causes the contact portion 221 to move vertically via the moving body 223.

The linear moving portion 222 has a rotary motor 2220, a worm gear 2221, and a screw mechanism 2222.

In the linear moving portion 222, a rotating shaft of the rotary motor 2220 rotates, and a rotational force thereof is transmitted to the screw mechanism 2222 via the worm gear 2221, and the screw mechanism 2222 rotates.

The rotary motor 2220 has load torque detecting means for detecting load torque acting thereon. The load torque detecting means, for example, applies a constant voltage to the rotary motor 2220 and detects a current value that changes based on the load of the rotary motor 2220.

The worm gear 2221 can prevent rotation of the rotating shaft of the rotary motor 2220. When a thrust force is generated in the screw mechanism 2222 in a thrust direction, the screw mechanism 2222 tends to rotate in a rotational direction. Therefore, the worm gear 2221 is installed between the screw mechanism 2222 and the rotary motor 2220, and the worm gear 2221 prevents reverse rotation of the rotating shaft of the rotary motor 2220.

The moving body 223 moves by the linear moving portion 222 and has a nut portion (not illustrated) in a portion through which the screw mechanism 2222 penetrates, and the screw mechanism 2222 is fitted to the nut portion. By rotating the screw mechanism 2222, the moving body 223 moves in an arrow Y direction (vertical direction) in FIG. 3.

The moving body 223 has a nut portion with which the screw mechanism 2222 is fitted, and a translation guide (not illustrated) that guides the movement of the moving body 223. That is, the moving body 223 is fitted in the screw mechanism 2222 at the nut portion and moves inside the frame 225 in the arrow Y direction in FIG. 3 via the translation guide.

In the first example, the moving body 223 has a substantially rectangular parallelepiped shape, and the nut portion is formed substantially in a center of a horizontal cross section of the moving body 223 to penetrate in the arrow Y direction in FIG. 3, so that a rotational force of the screw mechanism 2222 acts evenly on the moving body 223.

In the first example, the translation guides are installed on left and right end surfaces of the moving body 223 in a longitudinal direction so that the moving body 223 can stably move in the arrow Y direction in FIG. 3. The translation guides may be installed on left and right inside the frame 225.

The moving body 223 is provided with the contact portion 221 that comes into contact with the ground surface via a spherical bearing 227.

The spherical bearing 227 is installed so that an end surface of the contact portion 221 comes into contact with the ground surface for the end surface (surface where the contact portion 221 comes into contact with the ground surface) of the contact portion 221 to follow the ground surface even when the ground surface is inclined.

Thus, since the second support portion 220 has the spherical bearing 227, for example, even when the ground surface is inclined, the end surface of the contact portion 221 can come into contact with the ground surface for the end surface of the contact portion 221 to follow the ground surface.

As the moving body 223 descends, the contact portion 221 comes into contact with the ground surface. The moving body 223 descends, and the load torque detecting means detects (changes in the load (current value) of the rotary motor 2220) the load (current value) of the rotary motor 2220 when the contact portion 221 comes into contact with the ground surface, in such a manner that the control unit 30 determines that the contact portion 221 comes into contact with the ground surface, stops the rotary motor 2220, and stops the moving body 223.

When the contact portion 221 does not come into contact with the ground surface due to a state of the ground surface, the photointerrupter 224 detects excessive movement of the moving portion 223, stops the rotary motor 2220, and stops the moving body 223. The moving body 223 is prevented from falling below a predetermined position.

In the first example, two contact portions 221 installed on the moving body 223 are installed almost evenly from the screw mechanism 2222 on left and right sides of the screw mechanism 2222 to stably maintain the position and posture of the mobile robot 1.

Fixing members 226 are respectively installed on outer left and right sides of the frame 225. The fixing members 226 secure the second support portion 220 to be fixed to the vehicle body 250.

Next, features of the first support portion 210 and the second support portion 220 will be described.

As illustrated in FIG. 2, in the first support portion 210, the wheel 212 is always in contact with the ground surface due to the elastic portion 213, so the first support portion 210 always supports the weight of the mobile robot 1. The elastic portion 213 has an optimum predetermined spring constant for absorbing the impact received by the wheel 212 from the uneven road surface (passively buffering an external force received from the uneven road surface).

On the other hand, as illustrated in FIG. 3, in the second support portion 220, the contact portion 221 is vertically moved by the linear moving portion 222 via the moving portion 223. That is, the contact portion 221, the moving portion 223, and the linear moving portion 221 can support the weight of the mobile robot 1, as necessary.

The contact portion 221 of the second support portion 220 has higher rigidity than the elastic portion 213 of the first support portion 210. As a result, it is possible to simultaneously and stably absorb the impact received from the uneven road surface during movement and maintain the position and posture of the mobile robot 1 during operation.

The linear moving portion 222 in the second support portion 220 has a higher stiffness than the elastic portion 213 in the first support portion 210.

In the mobile robot 1, at least one second support portion 220 is installed outside (front side in the movement direction of the mobile robot 1) the movement direction (synonymous with the movement direction of the movement mechanism 20) of the mobile robot 1 from an installation position (forward side) of the first support portion 210 on a mounting position (installation position in the arrow A direction in FIG. 1: installation position of the dual-arm robot 10) side of the dual-arm robot 10 among the four first support portions 210 installed on the front, back, left, and right sides of the movement mechanism 20.

In particular, the second support portion 220 is installed forward in the movement direction of the mobile robot 1 from the central axles of the two front wheels 212 of the first support portion 210. The installation position of the second support portion 220 may be determined according to a mode of use of the dual-arm robot 10, and may be located further on an outer side (position closer to the outer periphery portion) than the installation position of the first support portion 210 with respect to the working direction (movement direction) of the dual-arm robot 10.

In the first example, only one second support portion 220 is installed between the front two wheels 212 and forward of central axes of the front two wheels 212. Thus, in first example, one second support portion 220 is installed outside the installation position of the first support portion 210 in the forward movement direction of the dual-arm robot 10.

Next, a state during movement of the mobile robot 1 described in the first example will be described.

FIG. 4 is an explanatory diagram for illustrating the state of the mobile robot 1 described in the first example when the robot moves.

The mobile robot 1 moves from an initial position toward a workbench 50 to perform dispensing work and stirring work on the workbench 50. The mobile robot 1 can also carry containers, container trays, and the like in which liquids such as reagents and samples as work targets are stored.

A test tube 501 containing a liquid such as a reagent or a sample as a work target, a pipette 502 for aspirating or discharging a predetermined amount of liquid, and the like are installed on the workbench 50.

During the movement of the mobile robot 1, the contact portion 221 of the second support portion 220 retreats upward due to the linear moving portion 222 and is separated from the ground surface. Here, the mobile robot 1 supports a weight of the robot only with the first support portion 210.

When moving to the workbench 50, the stereo camera unit 111 installed in the head portion 110 of the dual-arm robot 10 measures the distance to the workbench 50, and the laser range finder 240 installed in the movement mechanism 20 measures the distance to the workbench 50.

Next, a support structure of the mobile robot 1 described in the first example when moving will be described.

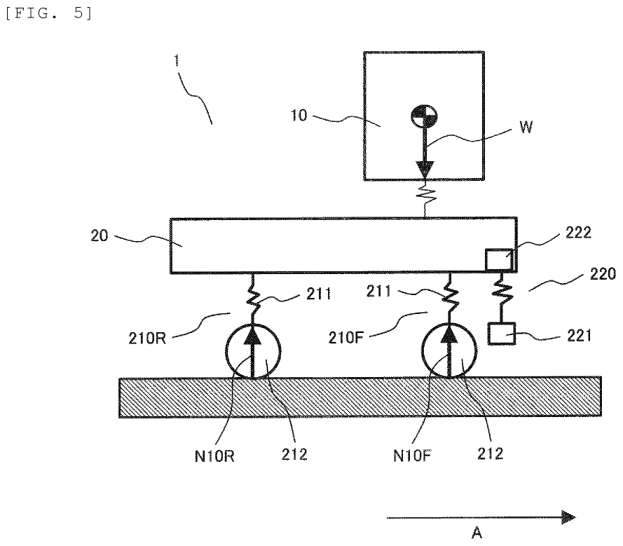

FIG. 5 is a schematic diagram for illustrating the support structure of the mobile robot 1 described in the first example when moving.

While the mobile robot 1 is moving, the contact portion 221 of the second support portion 220 is separated from the ground surface, and a weight W of the mobile robot 1 is supported only by the first support portion 210.

When it is assumed that a load (force) acting on a front first support portion 210F (wheel 212) is N10F and a load (force) acting on a rear first support portion 210R (wheel 212) is N10R, W=N10R+N10F is satisfied.

A magnitude of a biasing force of the first support portion 210 is adjusted so that the wheel 212 does not separate from the ground surface due to expansion and contraction of the elastic portion 213 when the wheel 212 rides on a convex portion or falls into a concave portion.

Therefore, even when the mobile robot 1 moves on an uneven road surface, the mobile robot 1 can absorb the impact received from the uneven road surface, so the mobile robot 1 can move stably on the uneven road surface. Thus, it is possible to prevent the posture change of the mobile robot 1 during movement.

Next, a state in which the mobile robot 1 described in the first example has moved to the workbench 50 and stopped will be described.

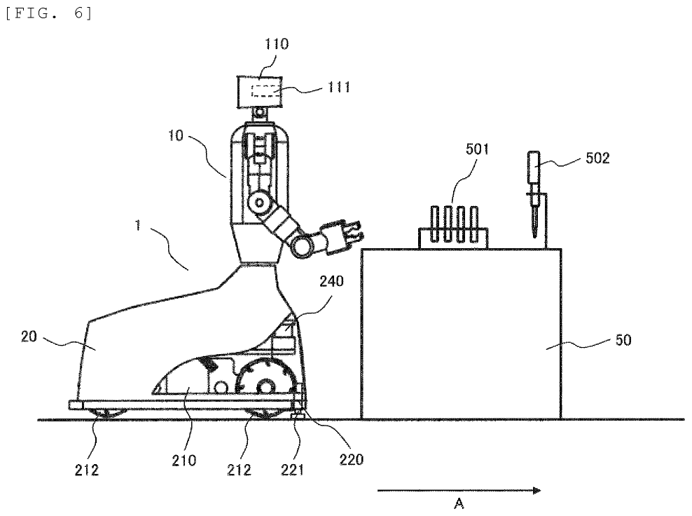

FIG. 6 is an explanatory diagram illustrating a state in which the mobile robot 1 described in the first example has moved to the workbench 50 and stopped.

The mobile robot 1 approaches the workbench 50 within a certain distance and stops.

When approaching the workbench 50, the stereo camera unit 111 installed in the head portion 110 of the dual-arm robot 10 measures the distance to the workbench 50, and the laser range finder 240 installed in the movement mechanism 20 measures the distance to the workbench 50.

Distance measurement by the stereo camera unit 111 and laser range finder 240 is controlled by the control unit 30 installed in the mobile robot 1.

When the mobile robot 1 detects completion of movement, the mobile robot 1 stops and makes the second support portion 220 come into contact with the ground surface. Then, by a signal transmitted from the control unit 30, the contact portion 221 of the second support portion 220 descends, the contact portion 221 comes into contact with the ground surface, and the position and posture of the mobile robot 1 (especially the movement mechanism 20) are fixed.

Here again, using the position detecting means of the stereo camera unit 111 or the laser range finder 240, for example, the distance to the workbench 50 may be measured, and using a map created in advance, or, for example, using GPS or the like, the position of the robot may be calculated, and then a deviation between the position and a preset operating position may be corrected. The calculation of the position is performed by the control unit 30.

When the stop position differs from a planned position by detecting the position of the robot, it is possible to correct a trajectory of the articulated arm 100 in various works to be carried out later. The trajectory correction is preferably performed while the contact portion 221 of the second support portion 220 comes into contact with the ground surface, that is, the posture of the mobile robot 1 (especially the movement mechanism 20) is stabilized.

Next, the support structure in which the mobile robot 1 described in the first example has moved to the workbench 50 and has stopped will be described.

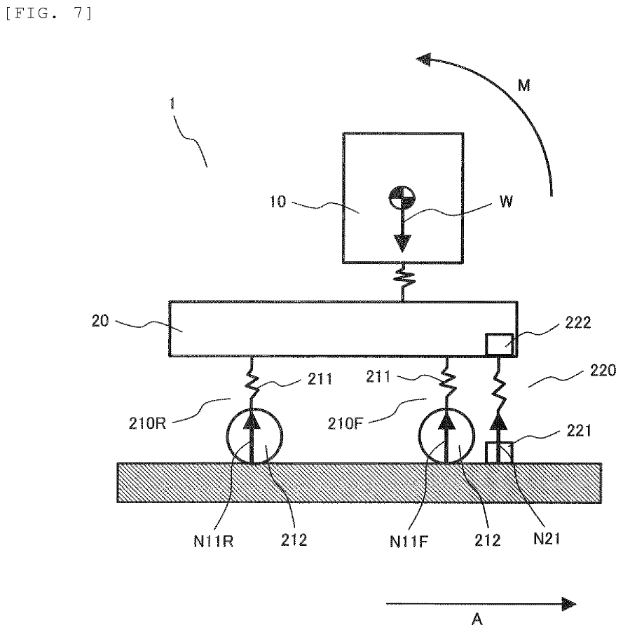

FIG. 7 is a schematic diagram for illustrating a support structure in which the mobile robot 1 described in the first example has moved to the workbench 50 and stopped.

When the mobile robot 1 stops and the contact portion 221 of the second support portion 220 comes into contact with the ground surface, the first support portion 210 and the second support portion 220 are arranged in parallel to support the weight of the mobile robot 1 at the same time. Then, part of the weight W of the mobile robot 1 that was supported only by the first support portion 210 during movement is also supported by the second support portion 220.

When it is assumed that a load (force) acting on the front first support portion 210F (wheel 212) is N11F, a load (force) acting on the rear first support portion 210R (wheel 212) is N11R, and a load (force) acting on the second support portion 220 (contact portion 221) is N21, W=N11R+N11F+N21 is satisfied. That is, when the dual-arm robot 10 operates, the contact portion 221 in the second support portion 220 and the wheel 212 in the first support portion 210 come into contact with the ground surface.

As such, the first support portion 210 and the second support portion 220 are arranged in parallel to support the weight of the mobile robot 1 at the same time, so that the posture of the mobile robot 1 (especially the movement mechanism 20) can be stabilized.

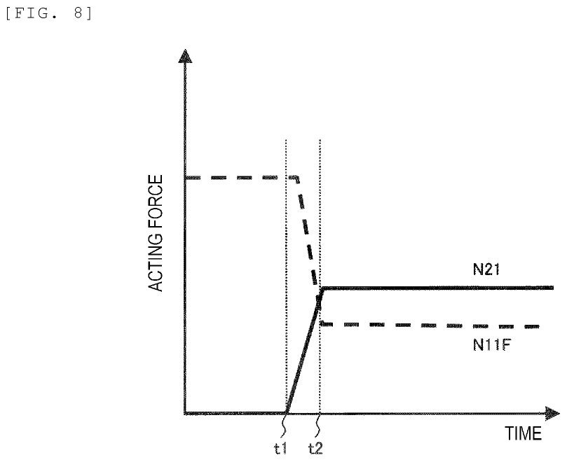

Next, time transitions of the load N11F acting on the front first support portion 210 of the mobile robot 1 described in the first example and the load N21 acting on the second support portion 220 will be described. Here, the operation of the second support portion when the robot is stopped will be described with reference to FIG. 8.

FIG. 8 is a graph for illustrating the time transitions of the load N11F acting on the front first support portion 210 and the load N21 acting on the second support portion 220 of the mobile robot 1 described in the first example.

In FIG. 8, a horizontal axis indicates time, and a vertical axis indicates an acting force (load), representing the load N11F acting on the front first support portion 210F.

After a time (t1) when the mobile robot 1 stops and the contact portion 221 of the second support portion 220 comes into contact with the ground surface, the load N11F acting on the front first support portion 210 gradually decreases and the load N21 acting on the second support portion 220 gradually increases. Then, after a time (t2) when the rotary motor 2220 stops, the first support portion 210 and the second support portion 220 are arranged in parallel to support the weight of the mobile robot 1 at the same time.

That is, when the load N21 acting on the second support portion 220 reaches a predetermined value, the load torque detecting means detects that a load (current value) of the rotary motor 2220 exceeds a set value, and stops the rotary motor 2220.

After the rotary motor 2220 stops, the load N21 acts on the second support portion 220, and a thrust force in a thrust direction is generated in the screw mechanism 2222 that engages with the nut portion formed on the moving body 223 that is connected to the contact portion 221. When the thrust force is generated in the screw mechanism 2222 in the thrust direction, the screw mechanism 2222 tends to rotate in a rotation direction. Thus, the worm gear 2221 is installed between the screw mechanism 2222 and the rotary motor 2220, and the worm gear 2221 suppresses reverse rotation of the rotating shaft of the rotary motor 2220. As a result, the rotary motor 2220 is prevented from rotating in reverse, and the displacement of the second support portion 220 is also prevented.

Here, supporting the weight of the mobile robot 1 by the first support portion 210 and the second support portion 220 at the same time means that none of the four wheels 212 are separated from the ground surface. Therefore, all four wheels 212 are still in contact with the ground surface after the contact portion 221 comes into contact with the ground surface.

As a result, since the load N11F acting on the front first support portion 210 also supports part of the weight of the mobile robot 1, the load N21 acting on the second support portion 220 is reduced. As a result, the size of the second support portion 220 can be reduced.

Here, the load N11F acting on the front first support portion 210 is smaller than the load N21 acting on the second support portion 220. Therefore, the posture of the mobile robot 1 can be stabilized.

Next, a state in which the mobile robot 1 described in the first example is working on the workbench 50 will be described.

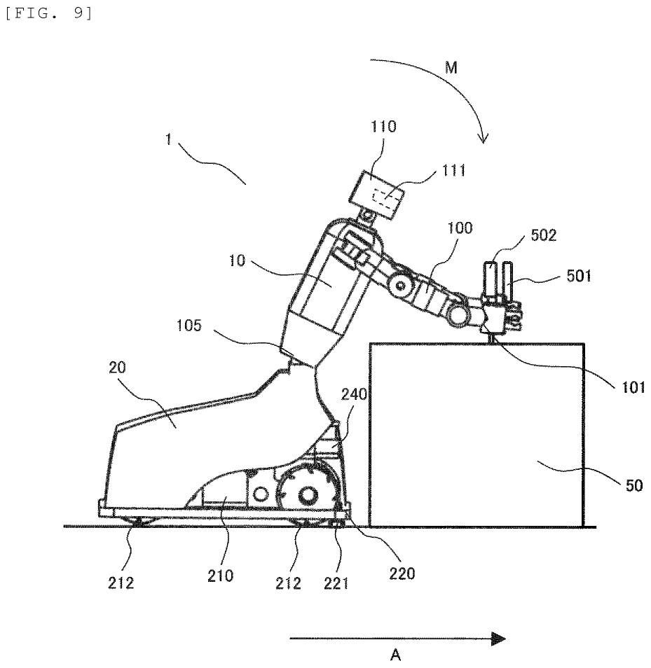

FIG. 9 is an explanatory diagram for illustrating the state in which the mobile robot 1 described in the first example is working on the workbench 50.

The mobile robot 1 (movement mechanism 20) approaches the workbench 50 and stops. The contact portion 221 of the second support portion 220 is brought into contact with the ground surface.

Here, the mobile robot 1 operates the actuator of the articulated arm 100 of the dual-arm robot 10, extends the articulated arm 100 to a predetermined position, and grips the test tube 501 or the pipette 502 with a hand 101. Then, on the workbench 50, the dispensing work and the stirring work are performed.

Here, the dual-arm robot 10 may tilt forward with respect to the movement mechanism 20. In other words, the dual-arm robot 10 may tilt the waist portion 105 forward in the movement direction (arrow A direction in FIG. 9) of the mobile robot 1. Thereby, the dual-arm robot 10 can improve workability on the workbench 50.

When gripping the test tube 501 or the pipette 502 with the hand 101, using the stereo camera unit, it is possible to measure the distance to the workbench 50 or the distance to a target point on the workbench 50, and it is also possible to correct the position and posture by observing the work target or a target marker.

After the dual-arm robot 10 completes all works such as dispensing works and stirring works, the robot puts the test tube 501 and pipette 502 gripped by the hand 101 at a predetermined position, and then the dual-arm robot 10 returns to the initial posture, separates the contact portion 221 of the second support portion 220 from the ground surface, and returns to the initial position by the movement mechanism 20.

When working on another workbench or transporting a processed work target to another place after all work is completed, again, the contact portion 221 of the second support portion 220 is separated from the ground surface and the mobile robot 1 is moved by the movement mechanism 20.

Next, the support structure in which the mobile robot 1 described in the first example is working on the workbench 50 will be described.

FIG. 10 is a schematic diagram for illustrating the support structure of the mobile robot 1 described in the first example when the robot is working on the workbench 50.

During operation of the mobile robot 1, the dual-arm robot 10 works on the workbench 50, so the articulated arm 100 is extended. To improve workability on the workbench 50, the dual-arm robot 10 may tilt the waist portion 105 forward.

As a result, the position of the center of gravity of the dual-arm robot 10 installed on the movement mechanism 20 changes in an arrow a direction in FIG. 10. Due to the change in the position of the center of gravity of the dual-arm robot 10, a moment M of force may act on the mobile robot 1 in a direction in which the entire mobile robot 1 is tilted forward.

When it is assumed that a load (force) acting on the front first support portion 210F (wheel 212) is N12F, a load (force) acting on the rear first support portion 210R (wheel 212) is N12R, and a load (force) acting on the second support portion 220 (contact portion 221) is N22, W=N12R+N12F+N22 is satisfied. That is, when the dual-arm robot 10 operates, the contact portion 221 in the second support portion 220 and the wheel 212 in the first support portion 210 come into contact with the ground surface.

As such, the first support portion 210 and the second support portion 220 are arranged in parallel to support the weight of the mobile robot 1 at the same time, so that the posture of the mobile robot 1 can be stabilized.

Since the second support portion 220 is installed in the forward movement direction of the mobile robot 1, even when such a moment M of force acts on the mobile robot 1, the posture of the mobile robot 1 can be stabilized.

In the mobile robot 1 described in the first example, the installation position of the second support portion 220 is forward of the installation position of the first support portion 210F in the movement direction of the mobile robot 1 (arrow A direction in FIG. 10). In the mobile robot 1 described in the first example, the second support portion 220 is installed outside the movement direction of the mobile robot 1, that is, a direction in which the articulated arm 100 of the dual-arm robot 10 extends, from the installation position of the first support portion 210F. As a result, the posture of the mobile robot 1 can be stabilized while the dual-arm robot 10 is operating.

The mobile robot 1 contracts the contact portion 221 of the second support portion 220 during movement to separate the contact portion 221 from the ground surface. The mobile robot 1 extends the contact portion 221 of the second support portion 220 during operation, and makes the contact portion 221 come into contact with the ground surface. As a result, the elastic portion 213 of the first support portion 210 can absorb the impact received from the uneven road surface during movement, and the second support portion 220 can stabilize the posture of the mobile robot 1 during movement.

In other words, the second support portion 220 comes into contact with the ground surface during operation, so even when the articulated arm 100 moves in the working direction or the dual-arm robot 10 tilts in the working direction, the second support portion 220 supports the weight of the mobile robot 1, stabilizes the posture of the mobile robot 1, and prevents changes in the posture of the mobile robot 1.

Next, the time transition of the load N12F acting on the front first support portion 210 of the mobile robot 1 described in the first example and the load N22 acting on the second support portion 220 will be described.

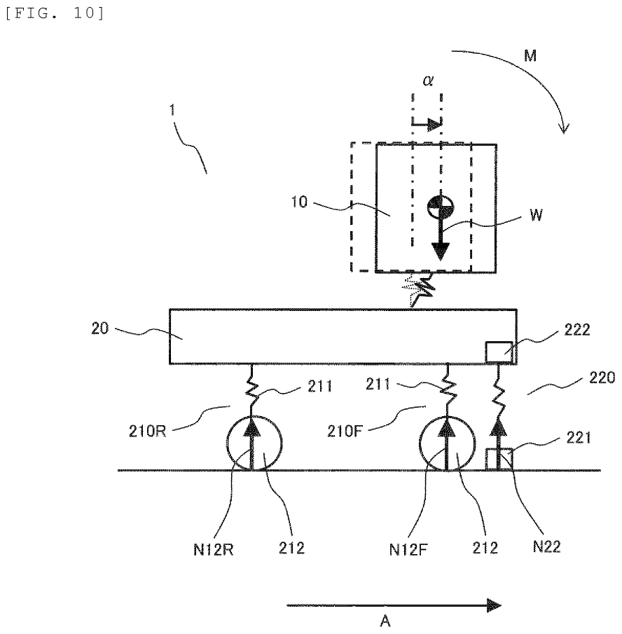

FIG. 11 is a graph for illustrating time transitions of the load N12F acting on the front first support portion 210 and the load N22 acting on the second support portion 220 of the mobile robot 1 described in the first example.

In FIG. 11, a horizontal axis indicates time, and a vertical axis indicates the acting force (load) and the position of the center of gravity, representing the load N12F acting on the front first support portion 210F.

Here, as illustrated in FIG. 11, for example, t3 indicates a time at which the articulated arm 100 starts to extend, and the center of gravity position α of the dual-arm robot 10 starts to change. t4 indicates a time at which the articulated arm 100 finishes extending and the change in the center of gravity position α of the dual-arm robot 10 stops. t5 indicates a time at which the articulated arm 100 starts to contract and the center of gravity position α of the dual-arm robot 10 starts to change. t6 indicates a time at which the articulated arm 100 is completely contracted and the change in the center-of-gravity position α of the dual-arm robot 10 stops. Thus, the center of gravity position α of the dual-arm robot 10 changes.

As the center of gravity position α of the dual-arm robot 10 changes, the load N22 acting on the second support portion 220 also changes as illustrated in FIG. 11. However, the load N12F acting on the front first support portion 210F is substantially constant. In other words, the second support portion 220 absorbs the change in the load caused by the change in the center of gravity position α of the dual-arm robot 10. Thereby, the posture of the mobile robot 1 can be stabilized.

As such, the moment M of force generated by the change in the center of gravity position α of the dual-arm robot 10 can be supported by the second support portion 220. Then, the load N12F acting on the front first support portion 210F becomes substantially constant, and thus the displacement of the front first support portion 210F can be prevented.

The load N22 acts on the second support portion 220, and a thrust force in the thrust direction is generated in the screw mechanism 2222 that engages with the nut portion formed on the moving body 223 connected to the contact portion 221. When a thrust force is generated in the screw mechanism 2222 in the thrust direction, the screw mechanism 2222 tends to rotate in the rotation direction. Therefore, the worm gear 2221 is installed between the screw mechanism 2222 and the rotary motor 2220, and the worm gear 2221 prevents the reverse rotation of the rotating shaft of the rotary motor 2220. As a result, the rotary motor 2220 is prevented from rotating in reverse, and the displacement of the second support portion 220 is also prevented.

### Second Example

Next, a structure of the movement mechanism 20 of the mobile robot 1 described in a second example will be described.

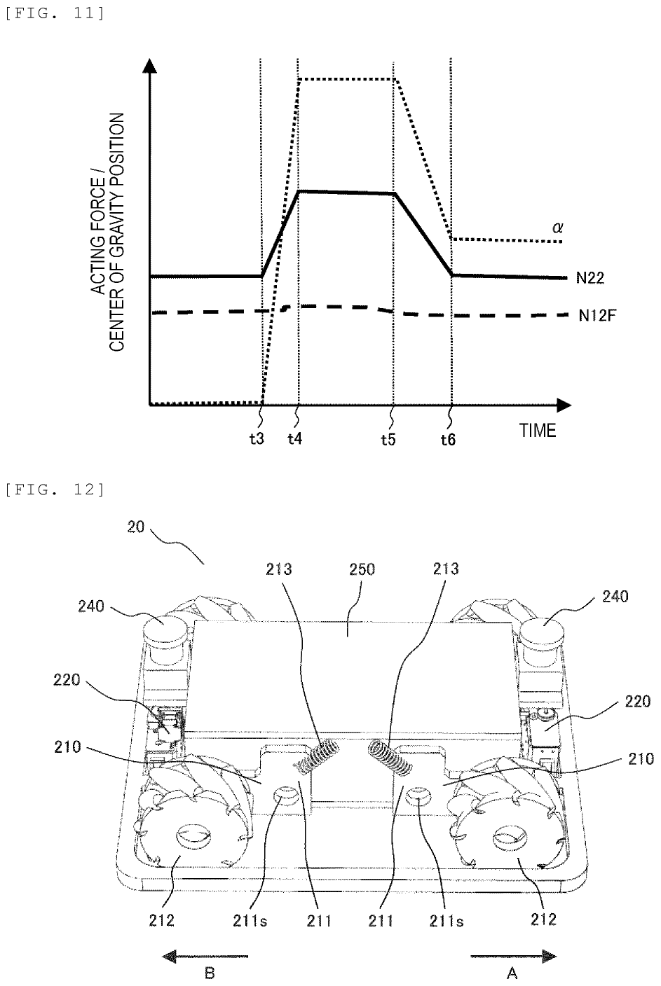

FIG. 12 is an explanatory diagram for illustrating the structure of the movement mechanism 20 of the mobile robot 1 described in the second example. In FIG. 12, the cover of the movement mechanism 20 of the mobile robot 1 is removed so that the internal structure can be seen to easily understand the internal structure of the movement mechanism 20 of the mobile robot 1.

The movement mechanism 20 described in the second example is different from the movement mechanism 20 described in the first example. In the movement mechanism 20 described in the second example, one second support portion 220 is installed between the front two wheels 212 and forward of the central axes of the front two wheels 212, and one second support portion 220 is installed between the rear two wheels 212 and rearward of the central axes of the rear two wheels 212. Thus, in the second example, one second support portion 220 is installed on the front outside (position closer to an outer periphery portion) of the installation position of the front first support portion 210 with respect to the movement direction (arrow A direction in FIG. 12 and arrow B direction in FIG. 12) of the dual-arm robot 10 in a front-rear direction, and one second support portion 220 is installed on the rear outside (position closer to an outer periphery portion) of the installation position of the rear first support portion 210.

As a result, even when the articulated arm 100 extends and operates in the front-rear direction, the weight of the mobile robot 1 can be supported, the posture of the mobile robot 1 can be stabilized, and the inclination of the vehicle body 250 can be prevented.

### Third Example

Next, a structure of the movement mechanism 20 of the mobile robot 1 described in a third example will be described.

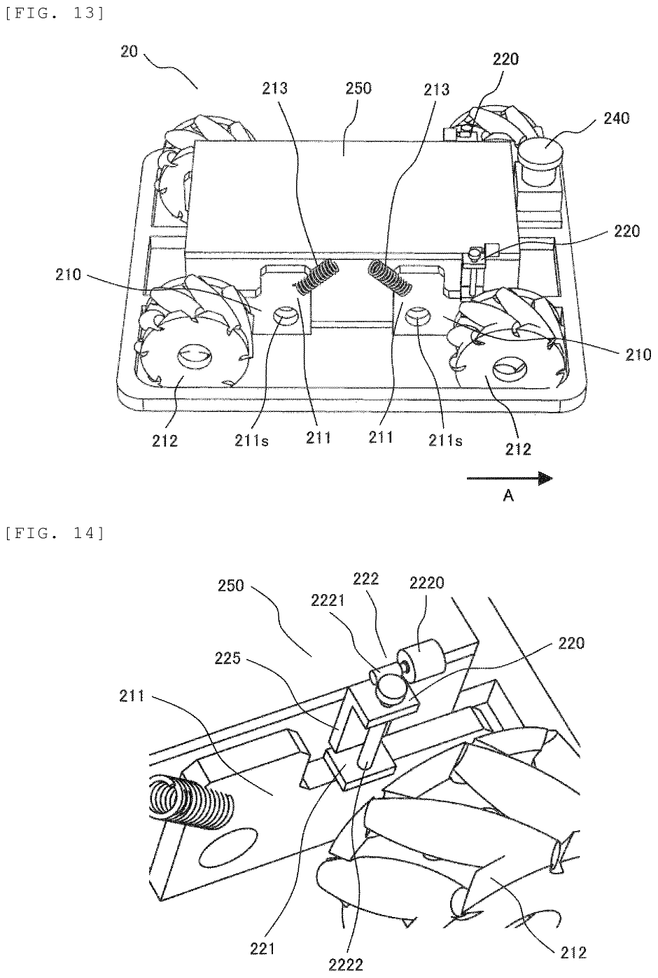

FIG. 13 is an explanatory diagram for illustrating the structure of the movement mechanism 20 of the mobile robot 1 described in the third example. In FIG. 13, the cover of the movement mechanism 20 of the mobile robot 1 is removed so that the internal structure can be seen to easily understand the internal structure of the movement mechanism 20 of the mobile robot 1.

The movement mechanism 20 described in the third example differs from the movement mechanism 20 described in the first example in the installation position of the second support portion 220 and the schematic configuration of the second support portion 220.

In the movement mechanism 20 described in the third example, the second support portions 220 are installed at two locations, left and right, on upper surfaces (upper surfaces of the L-shaped sides where the central axes of wheels 212 are installed) of the swing portions 211 on a side where (installation position in the arrow A direction in FIG. 13: installation position of the dual-arm robot 10) the dual-arm robot 10 is mounted, among the first support portions 210 installed at four locations on the front, rear, left, and right of the movement mechanism 20.

In particular, the second support portions 220 are installed behind the central axes of the two front wheels 212 of the first support portion 210 in the movement direction of the mobile robot 1, and in front of the swing axles 211s (and two front elastic portions 213 of the first support portion 210) of the two front swing portions 211 of the first support portion 210 in the movement direction of the mobile robot 1. That is, the second support portions 220 are installed at two left and right locations between the central axes of the wheels 212 and the swing axles 211s of the swing portions 211.

Thus, in the third example, two second support portions 220 are installed forward and outside of the installation positions of the swing axles 211s of the two front swing portions 211 of the first support portion 210 with respect to the movement direction of the dual-arm robot 10. Thereby, the posture of the mobile robot 1 can be stabilized.

Next, a vicinity of the second support portion 220 of the mobile robot 1 described in the third example will be described by enlarging the vicinity.

FIG. 14 is an explanatory diagram for illustrating an enlarged view of the vicinity of the second support portion 220 of the mobile robot 1 described in the third example.

The second support portion 220 has a linear moving portion 222, a contact portion 221 formed with a nut portion and fixed to the swing portion 211, and a frame 225 holding them.

The linear moving portion 222 has the rotary motor 2220, the worm gear 2221, and the screw mechanism 2222. In the linear moving portion 222, the rotating shaft of the rotary motor 2220 rotates, and the rotational force is transmitted to the screw mechanism 2222 via the worm gear 2221, and the screw mechanism 2222 rotates. By rotating the screw mechanism 2222, the contact portion 221 moves vertically. By moving the contact portion 221 downward, a load is applied to the swing portion 211, thereby stabilizing the posture of the mobile robot 1.

The present invention is not limited to the above-described examples, and includes various modification examples. For example, the above-described examples are specifically described to explain the present invention in an easy-to-understand manner, and are not necessarily limited to have all the configurations described.

Part of the configuration of one example can be replaced with part of the configuration of another example. The configuration of another example can be added to the configuration of one example. Part of the configuration of each example can be deleted, part of another configuration can be added, and part of another configuration can be substituted.

The accompanying drawings, which illustrate examples consistent with the principles of the present invention, are for the purpose of understanding the present invention and are not to be used as limiting interpretations of the present invention in any way. The descriptions in the specification are merely typical examples, and are not intended to limit the interpretation of the scope of claims in any way.

### REFERENCE SIGNS LIST

1: mobile robot
10: dual-arm robot
100: articulated arm
101: hand
105: waist portion
110: head portion
111: stereo camera unit
20: movement mechanism
210: first support portion
211: swing portion
211s: swing axle
212: wheel
213: elastic portion
220: second support portion
221: contact portion
222: linear moving portion
2220: rotary motor
2221: worm gear
2222: screw mechanism
223: moving body
224: photointerrupter
225: frame
226: fixing member
227: spherical bearing
230: bumper
240: laser range finder
250: vehicle body
30: control unit
50: workbench
501: test tube
502: pipette

1.-9. (canceled)

10. A mobile robot that has a working mechanism having an articulated arm and a movement mechanism for moving the working mechanism and that transports liquid and performs a dispensing work and a stirring work, wherein
the movement mechanism has a first support portion and a second support portion for supporting a weight of the mobile robot,
the first support portion has a swing portion that swings about a swing axle, a wheel that is installed on the swing portion, and an elastic portion that always applies a biasing force to bring the wheel into contact with a ground surface, and
the second support portion that is installed at a position closer to an outer periphery portion than a central axle of the wheel with respect to a movement direction of the movement mechanism and that has a moving body that moves up and down by a linear motion actuator, and a contact portion that is installed on the moving body, comes into contact with the ground surface when extended, and is separated from the ground surface when contracted.

11. The mobile robot according to claim 10, wherein
the contact portion of the linear motion actuator and the second support portion has higher stiffness than the elastic portion of the first support portion.

12. The mobile robot according to claim 10, wherein
when the working mechanism operates, the contact portion of the second support portion and the wheel of the first support portion come into contact with the ground surface.

13. The mobile robot according to claim 10, wherein
the linear motion actuator has a rotary motor, a linear moving portion in which a rotating shaft of the rotary motor rotates and a screw mechanism rotates by a rotational force transmitted to the screw mechanism via a worm gear, and a moving body that moves up and down by the linear moving portion.

14. The mobile robot according to claim 10, wherein
one second support portion is located at a position closer to the outer periphery portion with respect to a movement direction of the movement mechanism than the installation position of the first support portion, or the second support portions are installed one by one at front and rear positions near the outer periphery portion with respect to a front-rear direction of the movement mechanism.

15. The mobile robot according to claim 10, wherein
the working mechanism and the movement mechanism have position detection means for measuring a distance.

16. A mobile robot that has a working mechanism having an articulated arm and a movement mechanism for moving the working mechanism, wherein
the movement mechanism has a first support portion and a second support portion for supporting a weight of the mobile robot,
the first support portion has a swing portion that swings about a swing axle, a wheel that is installed on the swing portion, and an elastic portion that applies a biasing force to bring the wheel into contact with the ground surface,
the second support portion has a linear moving portion in which a rotating shaft of a rotary motor rotates and a screw mechanism rotates by a rotational force transmitted to the screw mechanism via a worm gear, and a contact portion that moves up and down by the linear moving portion, and
the second support portions are respectively installed on two left and right locations between central axles of the wheels and the swing axles.
